(19) United States
(12) Patent Application Publication
(10) Pub. No.: US 2010/0271647 A1
(43) Pub. Date: Oct. 28, 2010

(54) PRINT SYSTEM, METHOD OF CONTROLLING THE SYSTEM AND PROGRAM THEREOF

(75) Inventor: Yutaka Tokura, Ebina-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/727,110

(22) Filed: Mar. 18, 2010

(30) Foreign Application Priority Data
Apr. 22, 2009 (JP) 2009-104546

(51) Int. Cl. G06K 15/02

(52) U.S. Cl. 358/1.12

(57) ABSTRACT

A print system executes an inline-job that performs printing by a print apparatus on sheets fed from a sheet feeding unit and post-processing by a post-processing apparatus on the sheets printed by the print apparatus and executes an offline-job that performs post-processing by the post-processing apparatus without performing printing by the print apparatus on sheets fed from a sheet feeding unit. The print system determines whether or not the inline-job and the offline-job can be executed in parallel, controls such that the inline-job and the offline-job are executed in parallel in a case where it is determined that the inline-job and the offline-job can be executed in parallel, and receives the off-line job and performs the received off-line job after execution of the inline-job has been completed in a case where it is determined that the inline-job and the offline-job can not be executed in parallel.

### BACKGROUND OF THE INVENTION

1. Field of the Invention

The present invention relates to a print system, a method of controlling the system, and a program thereof.

2. Description of the Related Art

Conventionally, a POD (Print On Demand) print system that utilizes an electrophotographic print apparatus or an inkjet print apparatus has been proposed (see Japanese Patent Laid-Open Nos. 2004-310746 and 2004-310747). With such a POD print system, the need for an offset plate making process and other complicated tasks generally performed in the printing industry is eliminated. In addition, by using such a POD print system, post-processing, such as a stapling process and a bookbinding process, can be executed on sheets printed by the print apparatus by the post-processing apparatus. Such a job that performs printing by the print apparatus on sheets fed from a sheet feeding unit and post-processing by the post-processing apparatus on the sheets printed by the print apparatus is referred to as an “inline-job”.

In order to increase the processing efficiency of such inline-jobs, Japanese Patent Laid-Open No. 2007-220082 has proposed a print system that enables parallel processing of a plurality of inline-jobs.

However, it is conceivable that enabling of post-processing by a post-processing apparatus and the like connected to a print apparatus without performing printing by the print apparatus will be required in the future. Herein, a job that performs post-processing by the post-processing apparatus without performing printing by the print apparatus on sheets fed from a sheet feeding unit is referred to as an “offline-job”.

The conventional print system described above is not configured so as to enable post-processing by the post-processing apparatus connected to the print apparatus without performing printing by the print apparatus, and therefore consideration has not been given to the increasing of production efficiency when executing such offline-jobs.

### SUMMARY OF THE INVENTION

An aspect of the present invention is to eliminate the above-mentioned problems with the conventional technology.

A feature of the present invention is to efficiently execute an inline-job and an offline-job, the inline-job performing printing by a print apparatus and post-processing by a post-processing apparatus, and the offline-job performing post-processing by a post-processing apparatus without performing printing with a print apparatus.

According to an aspect of the present invention, there is provided a print system comprising: a first execution unit configured to execute an inline-job that performs printing by a print apparatus on sheets fed from a sheet feeding unit and post-processing on the sheets printed by the print apparatus by a post-processing apparatus; a second execution unit configured to execute an offline-job that performs post-processing by the post-processing apparatus without performing printing by the print apparatus on sheets fed from a sheet feeding unit; a determination unit configured to determine whether or not the inline-job and the offline-job can be executed in parallel; a control unit configured to perform control such that the inline-job executed by the first execution unit and the offline-job executed by the second execution unit are executed in parallel, in a case where it is determined by the determination unit that the inline-job and the offline-job can be executed in parallel, and to receive the off-line job and perform the received off-line job after execution of the inline-job has been completed in a case where it is determined by the determination unit that the inline-job and the offline-job can not be executed in parallel.

According to an aspect of the present invention, there is provided a method of controlling a print system, the method comprising: a first execution step of executing an inline-job that performs printing by a print apparatus on sheets fed from a sheet feeding unit and post-processing by a post-processing apparatus on the sheets printed by the print apparatus; a second execution step of executing an offline-job that performs post-processing by the post-processing apparatus without performing printing by the print apparatus on sheets fed from a sheet feeding unit; a determination step of determining whether or not the inline-job and the offline-job can be executed in parallel; and a control step of performing control such that the inline-job executed in the first execution step and the offline-job executed in the second execution step are executed in parallel, in a case where it is determined in the determination step that the inline-job and the offline-job can be executed in parallel, and to receive the off-line job and perform the received off-line job after execution of the inline-job is completed in a case where it is determined in the determination step that the inline-job and the offline-job can not be executed in parallel.

Further features and aspects of the present invention will become apparent from the following description of exemplary embodiments, with reference to the attached drawings.

### BRIEF DESCRIPTION OF THE DRAWINGS

The accompanying drawings, which are provided inside and constitute a part of the specification, illustrate embodiments of the invention and, together with the description, serve to explain the principles of the invention.

FIG. 1 is a diagram illustrating a configuration of a POD system according to an embodiment of the present invention.

FIG. 2 is a diagram illustrating a configuration of a print system according to the embodiment.

FIG. 3 depicts a cross-sectional view illustrating a configuration of a print system according to the embodiment.

FIG. 4 depicts a cross-sectional view illustrating an internal configuration of a glue binding apparatus according to the embodiment.

FIG. 5 depicts a cross-sectional view illustrating an internal configuration of a saddle stitching apparatus of the embodiment.

FIG. 6 depicts a cross-sectional view illustrating an internal configuration of a large-volume inserter of the embodiment.

FIG. 7 is a schematic diagram of a console unit of a print apparatus according to the embodiment.

FIG. 8 depicts a view illustrating an example of display of a settings screen for prompting a user to select the type of sheet processing.

FIG. 9 depicts a view illustrating an example of a settings screen for prompting a user to make a selection between “Permit” and “Not Permit” for parallel processing of an inline-job and an offline-job.

FIG. 10 depicts a view illustrating an example of a screen displayed when a user has selected a parallel processing condition setting for inline-job.

FIG. 11 depicts a view illustrating an example of a screen displayed when a user has selected a parallel processing condition setting for offline-job.

FIG. 12 depicts a view illustrating an example of a screen for setting the number of jobs held when a job number designation mode has been designated.

FIG. 13 depicts a view illustrating an example of a UI screen displayed when an inline-job sheet discharge process setting has been selected.

FIG. 14 depicts a view illustrating an example of a UI screen displayed when an offline-job sheet discharge process setting has been selected.

FIG. 15 is a flowchart describing an operation of a control unit performed when “auto” has been selected as a job parallel processing condition.

### DESCRIPTION OF THE EMBODIMENTS

Embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

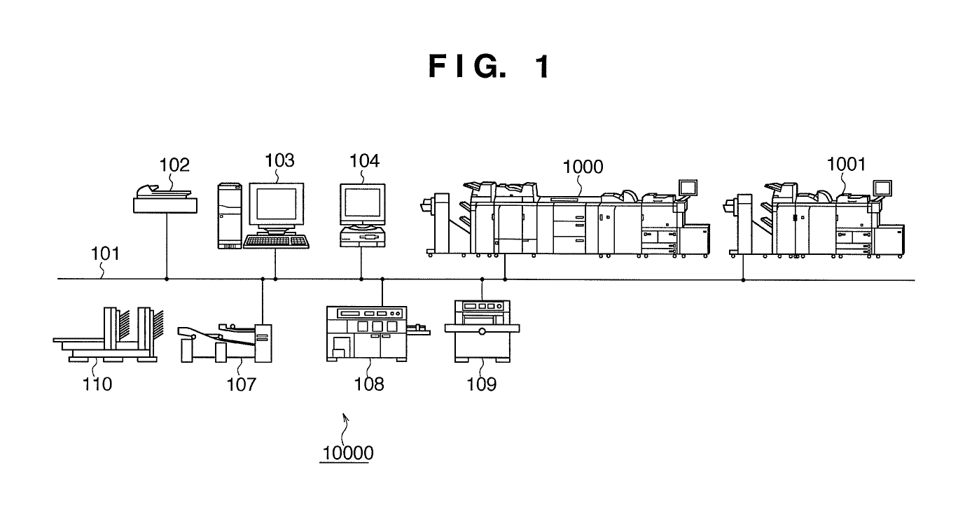

FIG. 1 is a diagram showing a configuration of a POD system according to an embodiment of the present invention.

This POD system 10000 includes print systems 1000 and 1001, a scanner 102, a server 103 (PC) and a client computer 104 (PC), which are connected via a network 101. The POD system 10000 also includes a sheet folding apparatus 107, a case binding apparatus 108, a trimmer 109, a saddle stitching apparatus 110, and so on.

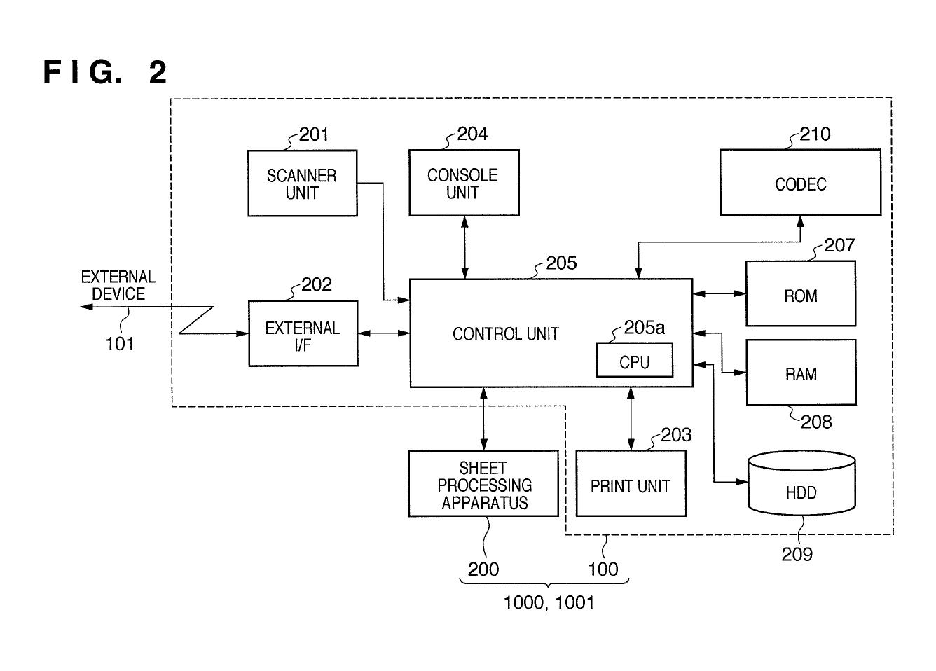

The PC 103 manages transmission and reception of data to and from various apparatuses connected to the network 101. The PC 104 transmits image data to a print apparatus 100 (FIG. 2) or the PC 103 via the network 101. The sheet folding apparatus 107 folds the sheets printed by the print apparatus 100. The case binding apparatus 108 performs case binding on the sheets printed by the print apparatus 100. The trimmer 109 trims the sheets printed by the print apparatus 100 for each stack of sheets that includes a plurality of sheets. The saddle stitching apparatus 110 performs saddle stitching on the sheets printed by the print apparatus 100.

When a user utilizes the sheet folding apparatus 107, the case binding apparatus 108, the trimmer 109 or the saddle stitching apparatus 110, the user takes out the sheets printed by the print system 1000 or 1001, loads them on an apparatus that the user wants to use, and causes the apparatus to execute processing. In addition, the plurality of apparatuses of the POD system 10000 of the present embodiment except for the saddle stitching apparatus 110 are connected to the network 101 and are configured so as to be capable of data communication with each other.

The print system 1001 has the same mechanism as that of the print system 1000, but the present invention is not limited thereto. In addition, the configuration of the present embodiment would be implemented if either of the print systems is present. The present embodiment will be described, as an example, in the context of the print system 1000 including various constituting elements described below.

Next, a configuration of the print system 1000 will be described with reference to the system block diagram of FIG. 2.

FIG. 2 is a diagram illustrating a configuration of the print systems 1000 and 1001 of the present embodiment. The print systems 1000 and 1001 each include the print apparatus 100 and a sheet processing apparatus 200. The present embodiment will be described taking an example in which the print apparatus 100 is a multi-function peripheral (MFP) having a plurality of functions such as a copy function, a print function, a facsimile function and so on. However, the print apparatus 100 may be a single function apparatus having only a copy function or a print function.

In FIG. 2, the units provided in the print system 1000 except for the sheet processing apparatus 200 are included in the print apparatus 100. In addition, any number of sheet processing apparatuses 200 can be connected to the print apparatus 100. The print systems 1000 and 1001 (the following will be described in the context of the print system 1000) can execute sheet processing on the sheets printed by the print apparatus 100 by using the sheet processing apparatus 200 connected to the print apparatus 100. However, it is also possible to configure the print system 1000 with only the print apparatus 100 without connecting the sheet processing apparatus 200.

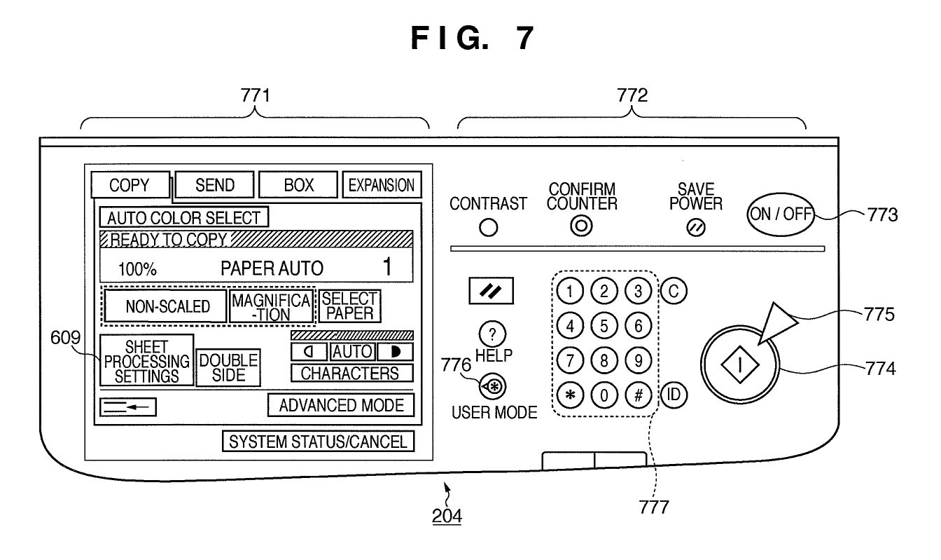

The sheet processing apparatus 200 is configured so as to be capable of communication with the print apparatus 100, and is capable of executing sheet processing as will be described later in response to instructions from the print apparatus 100. A scanner unit 201 reads an original image, converts the image into image data, and transfers the image data to another unit. An external I/F 202 performs transmission and reception of data to and from another apparatus connected to the network 101. A print unit 203 prints an image based on the input image data onto a sheet. A console unit 204 includes a hard key input unit (key input unit) 772 and a touch panel unit 771, which will be described later with reference to FIG. 7, and receives user instructions via the hard key input unit 772 and the touch panel unit 771. The console unit 204 also presents various displays on the touch panel of the console unit 204.

A control unit 205 includes a CPU 205a, and performs the overall control of the processing, operations and the like of the units of the print system 1000. In other words, the control unit 205 controls the operations of the print apparatus 100 as well as the operations of the sheet processing apparatus 200 connected to the print apparatus 100. A ROM 207 stores various computer programs that are executed by the CPU 205a of the control unit 205. For example, the ROM 207 stores a program that causes the control unit 205 to execute various processes of a flowchart, which will be described later, and a display control program that is necessary to display various settings screens, which will be described later. The ROM 207 also stores a program for the control unit 205 to execute operations for interpreting PDL (Page Description Language) code data received from the PC 103, the PC 104 and the like and expanding the code data into raster image data. The ROM 207 also stores a boot sequence, font information, and so on. A RAM 208 stores image data sent from the scanner unit 201 and the external I/F 202, various programs loaded from the ROM 207, and settings information. The RAM 208 also stores information regarding the sheet processing apparatus 200 (the number of sheet processing apparatuses 200 connected to the print apparatus 100, information regarding the functions of each sheet processing apparatus 200, the connection order of each sheet processing apparatus 200, etc.). A HDD (hard disk drive) 209 is made up of a hard disk, a driving unit that reads and writes data from and to the hard disk, and so on. The HDD 209 is a large-capacity storage device for storing image data that has been input from the scanner unit 201 and the external I/F 202 and compressed by a codec 210. The control unit 205 is capable of printing image data stored on the HDD 209 by using the print unit 203 based on user instructions. The control unit 205 is also capable of transmitting image data stored on the HDD 209 to external apparatuses such as the PC 103, the print system 1001 and so on via the external I/F 202 based on user instructions. The control unit 205 is also capable of acquiring image data from external apparatuses such as the PC 103, the print system 1001 and so on via the external I/F 202. The control unit 205 is also capable of searching for an external apparatus connected to the network 101, via the external I/F 202. The codec 210 compresses and decompresses image data and the like stored in the RAM 208 and the HDD 209 by using various compression formats such as JBIG (Joint Bi-level Image experts Group), JPEG (Joint Photograph Experts Group) and so on.

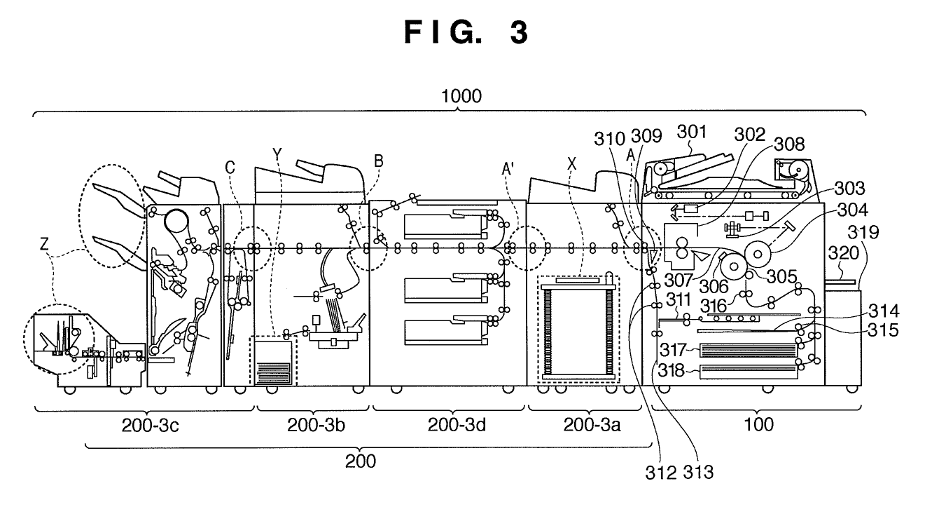

FIG. 3 depicts a cross-sectional view illustrating a configuration of the print system 1000 of the present embodiment.

An automatic document feeder (ADF) 301 conveys a stack of original loaded on the loading surface of a document tray to a platen glass by separating the original page by page from the first sheet of the original so that a scanner 302 scans the original. The scanner 302 reads the images of the original conveyed onto the platen glass and converts the images into image data by using a CCD. These units correspond to the scanner unit 201 of FIG. 2.

Next, a configuration of the print unit 203 will be described. A rotating polygon mirror (polygon mirror, etc.) 303 causes a light beam that has been modulated according to the image data, such as for example a laser light, to be incident thereon and directs the laser light to a photosensitive drum 304 as reflected scanning light via a reflecting mirror. A latent image formed by the laser light on the photosensitive drum 304 is developed with a toner, and the toner image is transferred to a sheet attached to a transfer drum 305. By executing such an instance of image forming processing sequentially for yellow (Y), magenta (M), cyan (C) and black (K) toners, a full color image is formed. After four instances of image forming processing, the sheet on the transfer drum 305 on which a full color image has been formed is separated by a separation pawl 306 and conveyed to a fixing unit 308 via a pre-fixing conveying device 307. The fixing unit 308 is made up of a combination of rollers and belts, contains a heat source such as a halogen heater, and melts and fixes the toner on the sheet to which the toner image has been transferred by the application of heat and pressure. A discharge flapper 309 is configured so as to be capable of swinging about a swing axis thereof so as to define the direction in which the sheet is conveyed. When the discharge flapper 309 swings clockwise in the diagram, the sheet is conveyed straightforward and discharged out of the print apparatus 100 by a discharge roller 310. The control unit 205 controls the print apparatus 100 to execute single-sided printing through a series of sequences as described above.

On the other hand, in the case of forming an image on both surfaces of the sheet, the discharge flapper 309 swings counterclockwise in the drawing to change the direction downward, and the sheet is sent to a double-sided feeding path. The double-sided feeding path includes a reversing flapper 311, reversing rollers 312, a reversing guide 313 and a tray for double-sided printing 314. The reversing flapper 311 swings about a swing axis thereof so as to define the direction in which the sheet is conveyed. When processing a double-sided print job, the control unit 205 performs control so as to swing the reversing flapper 311 counterclockwise in the drawing so that the sheet in which printing has been applied to a first surface of the sheet by the print unit 203 is sent to the reversing guide 313 via the reversing rollers 312. In a state in which the trailing end of the sheet is sandwiched by the reversing rollers 312, the rotation of the reversing rollers 312 is temporarily suspended. Subsequently, the reversing flapper 311 is swung clockwise in the drawing, and the reversing rollers 312 are rotated in the reverse direction, whereby the sheet is switched back and conveyed to the tray for double-sided printing 314 with the trailing end and the leading end of the sheet reversed. In the tray for double-sided printing 314, the sheet is temporarily stacked, and thereafter sent again to a registration roller 316 by a sheet feed roller 315. At this time, the sheet is conveyed with a second surface that is opposite the first surface facing the photosensitive drum 304. Then, a second image is formed on the second surface of the sheet in the same manner as in the process described above. The sheet in which images have been formed on both surfaces of the sheet is subjected to a fixing step, and discharged out of the print apparatus 100 via the discharge roller 310. Through a series of sequences as described above, the control unit 205 controls the print apparatus 100 to execute double-sided printing.

The print apparatus 100 also includes sheet feeding units in which sheets used for print processing are stored. The sheet feeding units include sheet feed cassettes 317 and 318 (for example, each capable of storing 500 sheets), a sheet feed deck 319 (for example, capable of storing 5000 sheets), a manual feed tray 320, and so on. In the sheet feed cassettes 317 and 318 and the sheet feed deck 319, various types of sheets of different sizes and materials can be loaded separately into each sheet feeding unit. In the manual feed tray 320, various sheets including special sheets such as OHP sheets can be loaded. The sheet feed cassettes 317 and 318, the sheet feed deck 319 and the manual feed tray 320 are each provided with sheet feed rollers, and the sheets are continuously fed, sheet by sheet, by the sheet feed rollers.

Next, the sheet processing apparatus 200 shown in FIG. 3 will be described.

As the sheet processing apparatus 200 of the print system 1000 of the present embodiment, any number of any types of apparatuses can be connected as long as it is possible to convey sheets from an upstream apparatus to a downstream apparatus via a sheet conveyance path. For example, as shown in FIG. 3, a large-capacity stacker 200-3a, an inserter 200-3d, a glue binding apparatus 200-3b and a saddle stitching apparatus 200-3c are connected in this order from the side close to the print apparatus 100. These can be selectively utilized by the print system 1000. Each of the sheet processing apparatuses 200 has a sheet discharge unit, and the user can take out sheets on which sheet processing has been performed from the sheet discharge unit of each sheet processing apparatus.

The control unit 205 receives a request to execute a type of sheet processing selected by the user from among candidates for the types of sheet processing that can be executed by the sheet processing apparatuses 200 connected to the print apparatus 100, together with a print execution request, via the console unit 204. In response to receiving the print execution request of the job to be processed via the console unit 204 from the user, the control unit 205 causes the print unit 203 to execute print processing requested by the job. The control unit 205 conveys the sheets of the job on which print processing has been performed to the sheet processing apparatus 200 that can execute the sheet processing selected by the user via a sheet conveyance path, and causes the sheet processing apparatus to execute the sheet processing.

For example, when the print system 1000 has the system configuration shown in FIG. 3, it is assumed that the job to be processed by the system that has been received together with a print execution request from the user is a job in which a large-volume stacking process by the large-capacity stacker 200-3a has been instructed to be carried out. Such a job is referred to as a “stacker job”. When the stacker job is processed with the system configuration in FIG. 3, the control unit 205 causes the sheets of the job printed by the print apparatus 100 to pass through a point A in FIG. 3 so as to convey the sheets to the inside of the large-capacity stacker 200-3a. After that, the control unit 205 causes the large-capacity stacker 200-3a to execute stacking processing of the job. Then, the control unit 205 causes the large-capacity stacker 200-3a to hold the printed material of the job stacked by the large-capacity stacker 200-3a in a discharge destination X provided inside the large-capacity stacker 200-3a without conveying the printed material to another apparatus (for example, a later apparatus).

Consequently, the user can take out the printed sheets of the stacker job held in the discharge destination X shown in FIG. 3 directly from the position of the discharge destination X. This configuration eliminates the need for a series of operations performed by the apparatuses and the user, such as conveying sheets to a discharge destination Z that is located the most downstream in the sheet convey direction of FIG. 3 and taking out the printed sheets of the stacker job from the discharge destination Z.

In the system configuration of FIG. 3, it is assumed that the job to be processed by the system that has been received together with a print execution request from the user is a job in which sheet processing (for example, glue binding such as a case binding process or a pad binding process) by the glue binding apparatus 200-3b has been instructed to be carried out. Such a job is referred to as a “glue binding job”. When the glue binding job is processed with the system configuration of FIG. 3, the control unit 205 conveys the sheets printed by the print apparatus 100 to the inside of the glue binding apparatus 200-3b via the point A, a point A′ and a point B of FIG. 3. After that, the control unit 205 causes the glue binding apparatus 200-3b to execute glue binding of the job. Then, the control unit 205 causes the glue binding apparatus 200-3b to hold the printed sheets of the job on which glue binding has been performed by the glue binding apparatus 200-3b in a discharge destination Y provided inside the glue binding apparatus 200-3b without conveying the printed sheet to another apparatus (for example, a later apparatus).

Furthermore, for example, in the system configuration of FIG. 3, it is assumed that the job to be processed by the system that has been received together with a print execution request from the user is a job in which sheet processing by the saddle stitching apparatus 200-3c has been instructed to be carried out. The sheet processing by the saddle stitching apparatus 200-3c includes, for example, a saddle stitching process, a punching process, a trimming process, a shift discharge process, a folding process, and so on. Here, such a job is referred to as a “saddle stitching job”. When such a saddle stitching job is processed with the system configuration of FIG. 3, the control unit 205 causes the sheets of the job printed by the print apparatus 100 to pass through the point A, the point A′ and the point B and a point C so as to convey the sheets to the saddle stitching apparatus 200-3c. After that, the control unit 205 causes the saddle stitching apparatus 200-3c to execute the sheet processing of the job. Then, the control unit 205 causes the saddle stitching apparatus 200-3c to hold the printed sheets of the saddle stitching job on which sheet processing has been performed by the saddle stitching apparatus 200-3c in the discharge destination Z of the saddle stitching apparatus 200-3c. The discharge destination Z has a plurality of discharge destination candidates, which are used to sort processed materials into discharge destinations by the type of sheet processing, because the saddle stitching apparatus 200-3c can execute a plurality of types of sheet processing.

Furthermore, for example, in the system configuration of FIG. 3, it is assumed that the job to be processed by the system that has been received together with a print execution request from the user is a job in which sheet processing by the inserter 200-3d has been instructed to be carried out. Such a job is referred to as an “inserter sheet-feeding job”. With the inserter sheet-feeding job, sheet processing apparatuses connected on the downstream side can be used.

A case where such an inserter sheet-feeding job is processed with the system configuration of FIG. 3 is considered. In this case, the control unit 205 inserts a sheet fed from the inserter 200-3d onto sheets of the job printed by the print apparatus 100, and conveys them to a sheet processing apparatus and performs sheet processing in accordance with designated sheet processing. In FIG. 3, because the glue binding apparatus 200-3b and the saddle stitching apparatus 200-3c are connected in the downstream of the inserter 200-3d, the inserter sheet-feeding job can be processed as a glue binding job or saddle stitching job as described above. In addition, the inserter sheet-feeding job does not require printing by the print apparatus 100. In other words, only sheets fed from the inserter 200-3d are conveyed to the downstream, and sheet processing can be performed on the sheets by using a designated sheet processing apparatus.

As described with reference to FIGS. 1 to 3, in the print system 1000 of the present embodiment, a plurality of sheet processing apparatuses can be connected to the print apparatus 100. The plurality of sheet processing apparatuses can be connected to the print apparatus 100 in any combinations. In addition, the order in which the plurality of sheet processing apparatuses are connected can be changed freely within a range where sheet conveyance paths can be established between the apparatuses. There are also a plurality of candidates for the types of sheet processing apparatuses that can be connected to the print apparatus 100.

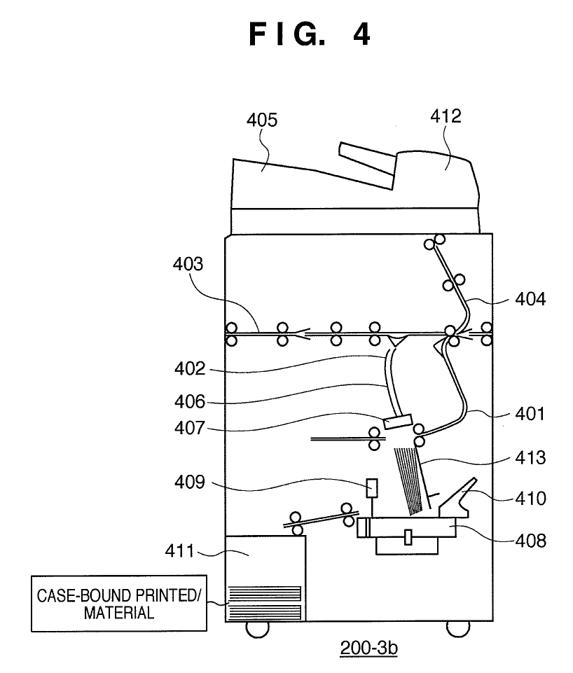

Next, an internal configuration of each type of sheet processing apparatus 200 that can be connected to the print apparatus 100 will be described with reference to FIGS. 4 to 6.

FIG. 4 depicts a cross-sectional view illustrating an internal configuration of the glue binding apparatus 200-3b of the present embodiment.

The glue binding apparatus 200-3b selectively conveys sheets conveyed from an upstream apparatus to any of three conveyance paths. The conveyance paths include a cover sheet path 401, a body sheet path 402 and a straight path 403. The glue binding apparatus 200-3b also has an inserter path 404. The inserter path 404 is a sheet conveyance path for conveying sheets placed on an inserter tray 405 to the cover sheet path 401. The straight path 403 of the glue binding apparatus 200-3b is a sheet conveyance path for conveying the sheets of a job that does not require glue binding by the glue binding apparatus 200-3b to a later apparatus. The body sheet path 402 and the cover sheet path 401 are sheet conveyance paths for conveying sheets required to create a case-bound printed material.

For example, when creating a case-bound printed material by using the glue binding apparatus 200-3b, the control unit 205 causes the print unit 203 to print data for the main text to be printed onto sheets for the main text of the case-bound printed material. When creating a single volume of case-bound printed material, a stack of sheets for the main text equivalent to a single volume is encased with a cover sheet. The stack of sheets for the main text in the case binding is called a “body”. The control unit 205 performs control so as to convey the sheets that have been printed by the print apparatus 100 and that serve as the body to the body sheet path 402. When performing case-binding, the control unit 205 executes a process for encasing the body printed by the print apparatus 100 with a cover sheet conveyed via the cover sheet path 401.

For example, the control unit 205 causes a stack unit 406 to sequentially stack the sheets that have been conveyed from an upstream-side apparatus and that serve as the body via the body sheet path 402. When the number of sheets, on which the main text data has been printed, that is equivalent to a single volume has been stacked in the stack unit 406, the control unit 205 causes a single cover sheet required by the job to be conveyed via the cover sheet path 401. Then, the control unit 205 controls a gluing unit 407 to perform a gluing process on the spine portion of one set of stacked sheets, which corresponds to the body. After that, the control unit 205 performs control such that the spine portion of the body and the center portion of the cover sheet are bonded by the gluing unit 407. When bonding the body to the cover sheet, the body is conveyed such that it is pushed down in the apparatus 200-3b, whereby a cover sheet folding process is performed such that the body is encased with a single cover sheet. After that, the single set of stacked sheets is stacked on a turn table 408 along a guide 413. After the single set of stacked sheets has been loaded onto the turn table 408, the control unit 205 causes a cutter unit 409 to execute a trimming process on the stack of sheets. At this time, a three-side trimming process that trims the three sides other than the side corresponding to the spine portion of the single set of stacked sheets can be executed by the cutter unit 409. After that, the control unit 205 causes the stack of sheets, on which a three-side trimming process has been performed, to be pushed toward a basket 411 by using a leaning unit 410 so as to store it in the basket 411.

The glue binding apparatus 200-3b is not only capable of processing sheets conveyed from an upstream apparatus, but also is capable of performing, by itself, a case binding process or a pad binding process. As an example, a case will be described in which case-bound printed material is created by using only the glue binding apparatus.

First, an operator loads sheets to be processed on the inserter tray 405. Then, the control unit 205 feeds the sheets loaded on the inserter tray 405 by using an inserter 412 to form a body. Next, the control unit 205 performs control such that the sheets serving as the body are conveyed to the body sheet path 402. Then, the control unit 205 executes a process for conveying a cover sheet also fed from the inserter tray 405 via the cover sheet path 401 and encasing the body sheets. The processes after this are the same as those described above.

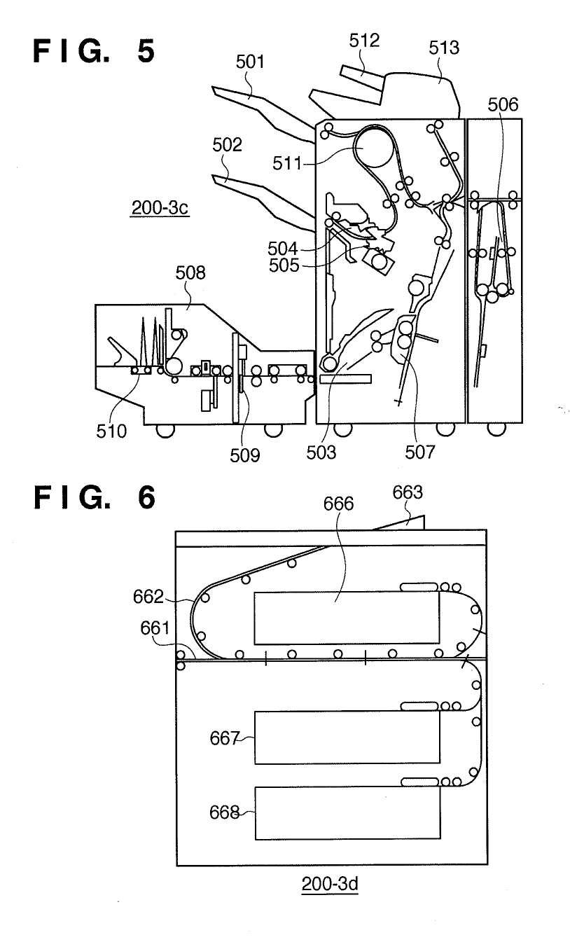

FIG. 5 depicts a cross-sectional view illustrating an internal configuration of the saddle stitching apparatus 200-3c of the present embodiment.

The saddle stitching apparatus 200-3c includes various units that selectively execute, on the sheets sent from the print apparatus 100, a stapling process, a trimming process, a punching process, a Z folding process, a shift discharge process, a saddle stitching process, and so on. The saddle stitching apparatus 200-3c does not have a straight path that has a function of conveying sheets to a later apparatus. Accordingly, when a plurality of sheet processing apparatuses are connected to the print apparatus 100, the saddle stitching apparatus 200-3c is connected at the tail end of the system as shown in FIG. 3.

The saddle stitching apparatus 200-3c also includes a sample tray 501 and a stack tray 502 that are disposed outside of the apparatus 200-3c, and a booklet tray 503 inside the apparatus 200-3c as shown in FIG. 5. When an instruction to perform stapling with the saddle stitching apparatus 200-3c has been received, the control unit 205 causes the sheets printed by the print apparatus 100 to be sequentially stacked in a process tray 504 provided in the saddle stitching apparatus 200-3c. When one stack of sheets has been stacked in the process tray 504, the control unit 205 causes a stapler 505 to perform stapling. After that, the control unit 205 causes the stapled stack of sheets to be discharged from the process tray 504 to the stack tray 502.

When executing a job in which a Z folding process by the saddle stitching apparatus 200-3c has been instructed to be carried out, the control unit 205 executes a process for folding the sheets printed by the print apparatus 100 into a Z shape by using a Z-folding unit 506. Then, the control unit 205 performs control so as to cause the folded sheets to pass through the saddle stitching apparatus 200-3c and to be discharged to a discharge tray such as the stack tray 502 or the sample tray 501.

When an instruction to perform a punching process by the saddle stitching apparatus 200-3c has been received, the control unit 205 executes a punching process on the sheets printed by the print apparatus 100 by using a punch unit 511. Then, the control unit 205 performs control so as to cause the sheets to pass through the saddle stitching apparatus 200-3c and to be discharged to a discharge tray such as the stack tray 502 or the sample tray 501.

When executing a job in which a saddle stitching process by the saddle stitching apparatus 200-3c has been instructed, the control unit 205 causes a saddle stitching unit 507 to stitch, in two places, the center portion of one set of a plurality of stacked sheets. After that, the control unit 205 causes the center portion of the stack of sheets to be held between rollers so as to fold the stack of sheets in half with respect to the center portion of the sheets, whereby a booklet such as a pamphlet can be created. The stack of sheets on which the saddle stitching process has been performed by the saddle stitching unit 507 in the above-described manner is conveyed to the booklet tray 503.

When an instruction to perform a trimming process has been received for the job in which a saddle stitching process has been instructed to be carried out, the control unit 205 causes the saddle-stitched stack of sheets to be conveyed from the booklet tray 503 to a trimmer 508. After that, the control unit 205 causes a cutter unit 509 to trim the stack of sheets conveyed to the trimmer 508, and causes a booklet hold unit 510 to hold the stack of sheets. As described above, the saddle stitching apparatus 200-3c is also configured so as to be capable of performing three-side trimming on a saddle-stitched stack of sheets.

In the case where the saddle stitching apparatus does not include the trimmer 508, the stack of sheets bound by the saddle stitching unit 507 can be taken out from the booklet tray 503.

The saddle stitching apparatus 200-3c is also configured so as to be capable of adding a sheet (for example, a cover sheet in which printing has already been applied) loaded on an insert tray 512 to sheets conveyed from the print apparatus 100 (printed by the print apparatus 100). Furthermore, the saddle stitching apparatus 200-3c is also configured so as to be capable of not only processing sheets conveyed from an upstream apparatus, but also performing, by itself, a stapling process, a trimming process, a punching process, a Z folding process, a shift discharge process, a saddle stitching process, and so on. However, in FIG. 5, the saddle stitching apparatus 200-3c is configured not to have a path for conveying sheets fed through an inserter 513 to the Z-folding unit. Accordingly, the saddle stitching apparatus 200-3c cannot implement a Z folding process by itself. However, the saddle stitching apparatus 200-3c is configured so as to be capable of conveying sheets conveyed from the upstream to the Z-folding unit 506. Accordingly, it is possible to feed sheets through an inserter or the like provided in a sheet processing apparatus connected in the upstream and execute sheet processing with the Z-folding unit 506. Therefore, the saddle stitching apparatus 200-3c is configured so as to be capable of executing only sheet processing without the use of the print apparatus 100.

FIG. 6 depicts a cross-sectional view illustrating an internal configuration of the large-volume inserter 200-3d of the present embodiment.

The large-volume inserter 200-3d conveys sheets conveyed from an upstream apparatus to the downstream through a straight path 661. The large-volume inserter 200-3d also feeds sheets loaded on each sheet feeding drawer by using each sheet feed motor, and conveys the sheets to the downstream through the straight path 661. An escape path 662 is a sheet conveyance path for discharging sheets to an escape tray 663. These provide a sheet conveyance path for conveying a double-fed sheet to the escape tray 663 when double feeding has been detected during sheet feeding. The sheet conveyance paths provided within the large-volume inserter 200-3d are provided with a plurality of sheet detection sensors for detecting a conveyance status of sheets or the occurrence of a sheet jam.

The large-volume inserter 200-3d also includes a CPU (not shown), which notifies the control unit 205 of sheet detection information from each sensor via a signal line for data communication. The control unit 205 recognizes the conveyance status of sheets and the occurrence of a sheet jam in the large-volume inserter 200-3d based on the information notified from the large-volume inserter 200-3d. In the case where another sheet processing apparatus is connected between the large-volume inserter 200-3d and the print apparatus 100, a CPU (not shown) of the other sheet processing apparatus notifies the control unit 205 of information regarding the sensors of the large-volume inserter 200-3d. Reference numerals 666 to 668 denote sheet feed decks that each can contain and feed sheets.

Next, a configuration of the console unit 204 will be described with reference to FIG. 7.

FIG. 7 is a schematic diagram of the console unit 204 of the print apparatus 100 according to the present embodiment.

The console unit 204 includes a touch panel unit 771 and a key input unit 772. The touch panel unit 771 has a liquid crystal display (LCD) and a transparent electrode attached onto the liquid crystal display, and displays various settings screens for receiving user instructions. The touch panel unit 771 has both a function of displaying various screens and a job receiving function of receiving user instructions. The key input unit 772 includes a power key 773, a start key 774, a stop key 775, a user mode key 776, and a numeric keypad 777. The start key 774 is used to cause the print apparatus 100 to start a copy job or transmission job. The numeric keypad 777 is used to input numerical values to be set such as the number of copies to be printed.

The control unit 205 controls the print system 1000 so as to perform various processes based on the user instructions received via various screens displayed on the touch panel unit 771 and the user instructions received via the key input unit 772.

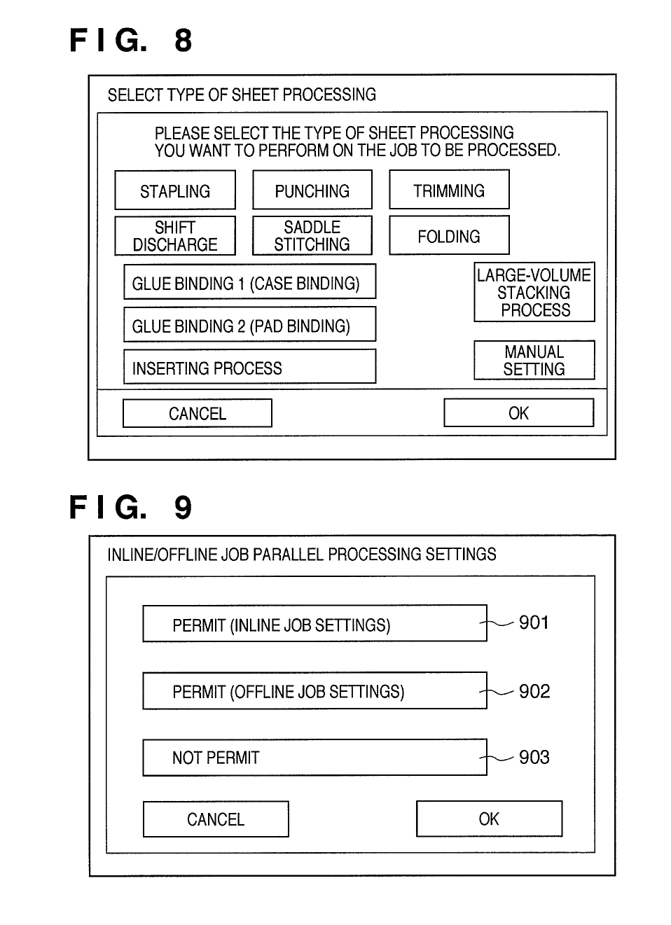

FIG. 8 depicts a view illustrating an example of display of a settings screen for prompting a user to select the type of sheet processing to be executed on the sheets printed by the print apparatus 100 of the present embodiment.

When a sheet processing settings key 609 shown in FIG. 7 displayed on the screen of the touch panel unit 771 has been pressed by the user, the control unit 205 causes the touch panel unit 771 to display a screen shown in FIG. 8. The screen shown in FIG. 8 is a settings screen configured so that the user can select the type of sheet processing that can be executed by using the sheet processing apparatuses 200 included in the print system 1000. The control unit 205 receives, via the screen of FIG. 8, settings of sheet processing to be executed in a job to be processed, and causes a sheet processing apparatus 200 to execute sheet processing in accordance with the settings.

In the case where sheet processing apparatuses 200 are connected to the print apparatus 100, it is also possible to employ a configuration in which the operator can register information for specifying the type of sheet processing apparatuses to be connected, the connection order, the number of sheet processing apparatuses, etc.

For example, a case where the print system 1000 is configured as shown in FIG. 3 is considered. In this case, registration information indicating that four sheet processing apparatuses, namely, the large-capacity stacker 200-3a, the inserter 200-3d, the glue binding apparatus 200-3b and the saddle stitching apparatus 200-3c, are connected to the print apparatus 100 in this order starting from the large-capacity stacker 200-3a is set. The control unit 205 causes the RAM 208 to hold the information regarding the sheet processing apparatuses 200 that has been set by the operator as system configuration information, and reads and refers to the information as appropriate. By doing so, the control unit 205 determines the type and number of sheet processing apparatuses connected to the print apparatus 100, the connection order, etc.

It is assumed here that the user has made settings to place the saddle stitching apparatus 200-3c, which does not have a straight path, midway between the plurality of sheet processing apparatuses. In this case, the control unit 205 causes the touch panel unit 771 to display an error message informing that the settings are invalid. Alternatively, instead of this, the control unit 205 may cause the touch panel unit 771 to display guidance information informing the operator to place the saddle stitching apparatus 200-3c at the tail end of the system.

In the present embodiment, the console unit 204 provided in the print apparatus 100 is shown as an example of a user interface unit applied in the print system 1000, but it is also possible to use another unit. For example, the print system 1000 may be configured so as to be capable of executing processes based on instructions received from a user interface unit provided in external apparatuses such as the PCs 103 and 104. In the case where the print system 1000 is remotely operated by such an external apparatus as described above, settings screens regarding the print system 1000 are displayed on a display unit of that apparatus.

By way of example, a case where processing based on an instruction from the PC 104 is performed will be described. When a print request has been received from the user, a CPU provided in the PC 104 causes a settings screen to be displayed on the display of the PC 104, and receives settings regarding print processing conditions from the operator of the PC 104 via the screen. Then, when a print execution request from the operator has been received, the CPU of the PC 104 associates the print processing conditions received via the screen with image data to be printed, and transmits the resulting data to the print system 1000 via the network 101 as a single job.

On the other hand, when the print execution request of the job has been received by the print system 1000 via the external I/F 202, the control unit 205 controls the print system 1000 to process the job transmitted from the PC 104 based on the print processing conditions transmitted from the PC 104. In this manner, various units can be used as user interfaces for the print system 1000. Accordingly, in the present embodiment, the receipt of an offline-job and the receipt of an inline-job can be performed from any of the console unit 204 and the PCs connected via the network 101.

As used herein, “inline-job” refers to a job that executes a first operation that performs printing by a print apparatus on sheets fed from a sheet feeding unit and post-processing by a post-processing apparatus on the printed sheets.

When executing an inline-job, the control unit 205 causes the print system 1000 to operate as follows.

First, the control unit 205 feeds sheets from any one of a plurality of sheet feeding units provided in the print system 1000. The plurality of sheet feeding units mentioned here include the sheet feed cassettes 317 and 318, the sheet feed deck 319 and the manual feed tray 320, which are shown in FIG. 3. The control unit 205 prints text and images on the fed sheets by using the print apparatus 100, and conveys the printed sheets to a sheet processing apparatus 200 via a sheet conveyance path. The sheet processing apparatus 200 performs a specific sheet process on the conveyed sheets and discharges the processed sheets. From which of the plurality of sheet feeding units sheets are fed is determined according to the details of the settings made by the user for a job to be executed. The type of sheet processing performed on the sheets is also determined according to the details of the settings made by the user for the job to be executed.

On the other hand, “offline-job” refers to a job that executes a second operation that performs post-processing by a post-processing apparatus without performing printing by a print apparatus on sheets fed from a sheet feeding unit. When executing such an offline-job, the control unit 205 causes the print system 1000 to operate as follows.

First, the control unit 205 feeds sheets from any one of a plurality of sheet feeding units provided in the print system 1000. The plurality of sheet feeding units mentioned here include, in addition to the sheet feed cassettes 317 and 318, the sheet feed deck 319 and the manual feed tray 320, the sheet feeding units provided in the inserter 200-3d and the inserters provided in the glue binding apparatus 200-3b and the saddle stitching apparatus 200-3c. The control unit 205 conveys the fed sheets to a sheet processing apparatus 200 via a sheet conveyance path without causing the print apparatus 100 to print text and images on the sheets. The sheets fed from the sheet feeding units of the inserter 200-3d, the inserter of the glue binding apparatus 200-3b or the inserter of the saddle stitching apparatus 200-3c are conveyed directly to the sheet processing apparatus 200 (for example, the glue binding apparatus 200-3b or the saddle stitching apparatus 200-3c). The sheet processing apparatus 200 performs a specific sheet process on the conveyed sheets and discharges the processed sheets. From which of the plurality of sheet feeding units sheets are fed is determined according to the details of the settings made by the user for a job to be executed. The type of sheet processing performed on the sheets is also determined according to the details of the settings made by the user for the job to be executed.

Next, various control operations executed by the control unit 205 of the present embodiment for the print system 1000 will be described below.

The print system 1000 stores data regarding a plurality of jobs on the HDD 209, and executes processing to print the data by using the print unit 203 of the print apparatus 100. The print system 1000 is also configured such that the print apparatus 100 and a plurality of sheet processing apparatuses 200 can be connected. The plurality of sheet processing apparatuses 200 that can be connected to the print apparatus 100 are each configured so as to be capable of executing sheet processing (also referred to as finishing or post-processing) on the sheets (also referred to as a printed material or printed medium) of a job printed by the print unit 203. Each sheet processing apparatus 200 is also configured such that the printed material obtained as a result of the apparatus executing sheet processing can be taken out from the sheet processing apparatus by the operator. In addition, the inserter 200-3d, which is one of the sheet processing apparatuses 200, is configured so as to be capable of selectively feeding the sheets loaded on the sheet feed decks of the inserter 200-3d to other sheet processing apparatuses 200. The print system 1000 of the present embodiment is also configured so as to be capable of selectively feeding the sheets printed by the print unit 203 to the plurality of sheet processing apparatuses 200 from the print unit 203.

The print system 1000 also has a function of processing jobs using only the sheet processing apparatuses 200 without performing printing by the print apparatus 100. The control unit 205 controls the print system 1000 to selectively execute a process that uses only the sheet processing apparatuses 200 and a process that uses the print apparatus 100 for each job to be processed based on operator instructions through a user interface unit (UI unit). The control unit 205 can also control the print system 1000 to execute such two processes together where appropriate.

The print system 1000 of the present embodiment has a flexible and/or convenient mechanism that enables execution of post-processing by a post-processing apparatus connected to a print apparatus without performing printing by the print apparatus. With this mechanism, for example, the print system 1000 of the present embodiment can receive an execution request for a specific type of job that performs post-processing by a sheet processing apparatus connected to the print apparatus 100 without performing printing by the print apparatus 100.

In the present embodiment, a configuration is shown in which the print unit 203 and/or the print apparatus 100 function as print apparatuses, and the sheet processing apparatuses 200 (for example, at least one of the finishers shown in FIGS. 4 to 6) connected to the print apparatus 100 function as post-processing apparatuses.

In the present embodiment, as the specific type of job mentioned above, a job (offline-job) that requires sheet processing (hereinafter referred to as “post-processing”) by a sheet processing apparatus 200 without requiring printing by the print unit 203 as described above is used as an example. For example, a job that executes post-processing by a sheet processing apparatus 200 without the involvement of printing by the print apparatus 100 corresponds to the specific type of job.

As described above, in the present embodiment, a job that requires execution of post-processing by a sheet processing apparatus 200 independently of (asynchronously of/non-concurrently with) print processing by the print apparatus 100 is described as a specific type of job. The control unit 205 controls the print system 1000 to process such a specific type of job.

In the present embodiment, the post-processing permitted to be carried out as the specific type of job includes:

(A) stapling process;

(B) punching process;

(C) trimming process;

(D) saddle stitching process;

(E) folding process;

(F) case binding process;

(G) pad binding process; and

(H) inserting process.

In the present embodiment, the processes (A) to (E) are configured so as to be selectively carried out by the saddle stitching apparatus 200-3c. The processes (F) and (G) are configured so as to be selectively carried out by the glue binding apparatus 200-3b. The process (H) is configured so as to be carried out by the large-volume inserter 200-3d.

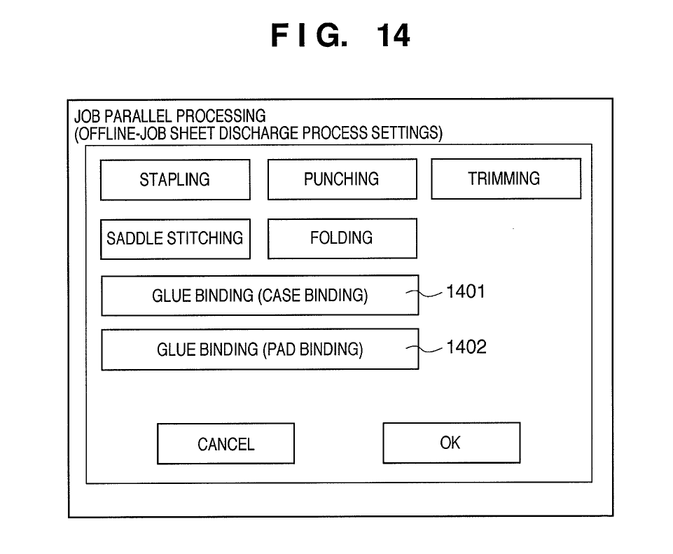

In addition, in the present embodiment, control is performed by the control unit 205 such that a plurality of selection candidates are displayed on a user interface as the post processes permitted to be carried out without the involvement of printing by the print apparatus 100. As a specific example thereof, a configuration is provided, which will be described later with reference to FIG. 13.

The points described above are merely illustrative, and any type of post-processing may be employed as a post process that can be executed without the involvement of printing. Furthermore, the configuration need not necessarily be such that a plurality of types of post processes can be selectively executed as in the present embodiment, and the present invention is not limited thereto. For example, a configuration in which there is only one type of post-processing that can be executed without performing printing is also encompassed by the present invention.

In addition, in the present embodiment, execution requests can be received by various user interfaces that are provided in the print system 1000 and that are configured so as to be capable of interactively responding to an operation of an operator. Examples of such user interfaces include the console unit 204 and/or the soft keys and hard keys provided in the console unit 204 and/or various user interface screens shown in the drawings, etc. However, these are merely illustrative, and the present invention is not limited thereto. For example, it is also possible employ a configuration in which an external apparatus different from the print system 1000 receives an execution request for a specific type of job. In this case, for example, a user interface provided in an external data generation source such as the network scanner 102, the PC 103 or the PC 104 receives such an execution request. In addition, in this case, a unit that is necessary for the print system 1000 to receive such a specific type of job from the outside, such as the external I/F 202, also functions as a receiving unit. As described above, the present embodiment can be modified and applied in various ways, and any system that has at least a configuration corresponding to the configuration demonstrated below as in the print system 1000 of the present embodiment is also applicable.

It is assumed, for example, that the control unit 205 has received an execution request for a specific type of job as described above via a user interface as described above. In this case, in response to the execution request, the control unit 205 performs control so as to cause a sheet processing apparatus 200 to perform post-processing on printed sheets (first printed material) created in advance for the specific type of job without causing the print apparatus 100 to carry out printing.

As described above, when an execution request for a specific type of job as described above has been received, the print system 1000 causes a post-processing apparatus as described above to execute post-processing on the first printed materials (sheets) created in advance for the job without causing the print apparatus 100 to carry out printing.

In the present embodiment, the sheet processing apparatuses 200 have a configuration in which a plurality of printed media (printed sheets) in which printing has already been applied can be fed as the first printed materials. The large-capacity stacker 200-3a, the saddle stitching apparatus 200-3c and the large-volume inserter 200-3d, which are shown as examples of the sheet processing apparatuses 200, include inserters, sheet feed decks 666 to 668 (FIG. 6) and the like as shown in the drawings. In the present embodiment, these units also function as units (sheet feeding units) for feeding printed sheets. And, first printed materials necessary for a specific type of job as described above are loaded onto such a feeding unit by the operator.

In the present embodiment, when an execution request for such a specific type of job is issued by the operator, the control unit 205 feeds the first printed materials from the feeding unit to a post-processing unit provided in a sheet processing apparatus 200 without causing the printed materials to pass through the print apparatus 100. After that, the control unit 205 causes the post-processing apparatus to execute post-processing on the first printed materials. In this manner, the control unit 205 can execute the post-processing of the job instructed by the user by using the sheet processing apparatus 200 without the involvement of printing by the print apparatus 100.

When executing a specific type of job as described above, it is possible to employ a configuration in which the first printed materials (sheets) used by the job are fed from a sheet feed cassette provided in the print apparatus 100. In this case, the first printed materials are introduced into a sheet processing apparatus 200 via a conveyance path of the print apparatus 100, but at this time, the control unit 205 performs control so as not to cause the print apparatus 100 to carry out printing on the first printed materials. When the printed materials have been introduced into the sheet processing apparatus 200, the control unit 205 performs control such that the sheet processing apparatus 200 executes post-processing instructed by the user on the printed materials.

Next, settings to permit parallel execution of a first operation corresponding to an inline-job and a second operation corresponding to an offline-job according to the embodiment of the present invention will be described.

FIG. 9 depicts a view illustrating an example of a settings screen for prompting a user to make a selection between “Permit” and “Not Permit” for parallel processing of a first operation corresponding to an inline-job and a second operation corresponding to an offline-job in the print system 1000 of the present embodiment.

When the user mode key 776 (FIG. 7) has been pressed by the user, the control unit 205 displays several settings screens. As one of the settings screens, a screen shown in FIG. 9 is displayed. It is assumed here that the screen includes three setting items: a parallel processing condition setting for inline-job 901, a parallel processing condition setting for offline-job 902, and a setting to not permit parallel processing (not permit) 903.

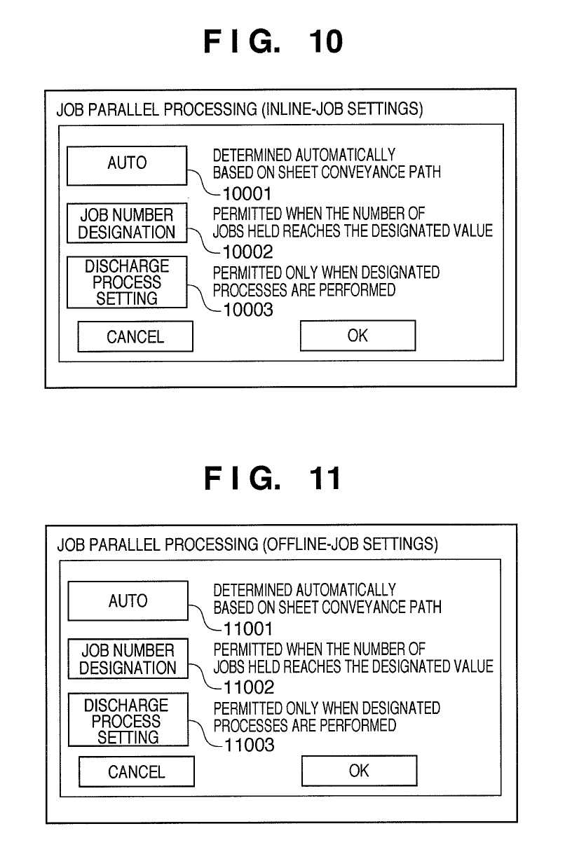

FIG. 10 depicts a view illustrating an example of a screen displayed when the user has selected the parallel processing condition setting for inline-job 901 in FIG. 9. Conditions for executing an offline-job in parallel with inline-jobs while the control unit 205 is executing the inline-jobs are set. The details set in this screen are held on the HDD 209. The control unit 205 determines whether or not to perform parallel execution of a first process corresponding to an inline-job and a second process corresponding to an offline-job by referring to the details held on the HDD 209.

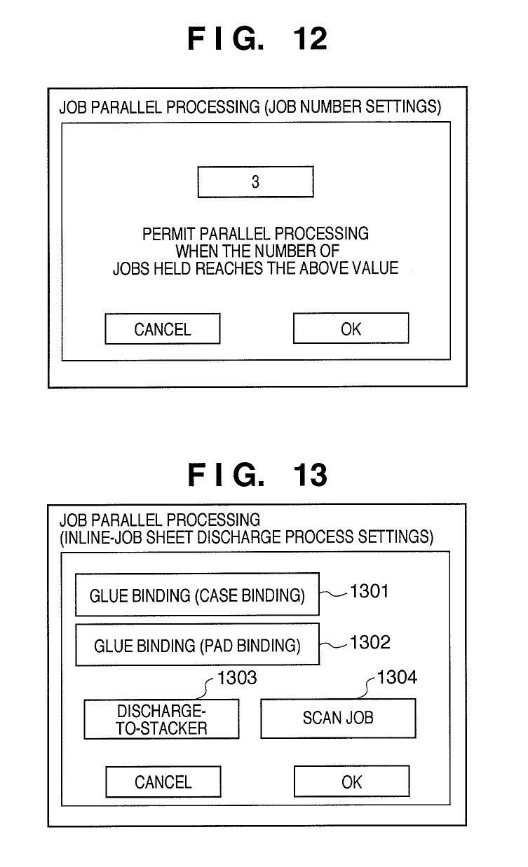

FIG. 11 depicts a view illustrating an example of a screen displayed when the user has selected the parallel processing condition setting for offline-job 902 in FIG. 9. Conditions for executing an inline-job in parallel with offline-jobs while the control unit 205 is executing the offline-jobs are set. The details set in this screen is held on the HDD 209. The control unit 205 determines whether or not to perform parallel execution of a first process corresponding to an inline-job and a second process corresponding to an offline-job by referring to the details held on the HDD 209. A detailed description thereof will be given below.

In FIG. 10, reference numeral 10001 denotes a button for an auto mode that automatically determines whether or not to execute parallel processing based on the sheet conveyance path of inline-jobs. Reference numeral 10002 denotes a button for a job number designation mode. The job number designation mode is a mode in which the number of inline-jobs held is set, and when the number of inline-jobs held reaches a set value, a first process corresponding to an inline-job and a second process corresponding to an offline-job are executed in parallel. Reference numeral 10003 denotes a discharge process setting button for setting whether or not to permit parallel execution of a first process and a second process for each type of offline-job executed in parallel with the execution of an inline-job.

In FIG. 11, reference numeral 11001 denotes a button for an auto mode that automatically determines whether or not to execute parallel processing based on the sheet conveyance path for offline-job. Reference numeral 11002 denotes a button for a job number designation mode. The job number designation mode is a mode in which the number of offline-jobs held is set, and when the number of offline-jobs held reaches a set value, a first process corresponding to an inline-job and a second process corresponding to an offline-job are executed in parallel. Reference numeral 11003 denotes a discharge process setting button for setting whether or not to permit parallel execution of a first process and a second process for each type of inline-job executed in parallel with the execution of an offline-job.

When the auto mode has been selected in FIGS. 10 and 11, in a situation where an inline-job and an offline-job have been received by the print system 1000, the sheet conveyance paths necessary for post-processing of these jobs are detected. For example, the sheet conveyance paths do not overlap between an inline-job in which sheet discharge to a stacker has been designated and an offline-job that uses only the glue binding apparatus 200-3b or the saddle stitching apparatus 200-3c. In such a case, the control unit 205 performs control so as to permit parallel processing of the inline-job and the offline-job.

FIG. 12 depicts a view illustrating an example of a job number designation settings screen displayed when the job number designation mode has been designated.

The screen shown in FIG. 12 is a screen displayed when the job number designation mode has been designated with the job number designation button 10002 of FIG. 10, in which a value used as a threshold for permitting parallel execution of the jobs can be set. In the example shown in FIG. 12, the value has been set to “3” by the user. In this case, when the number of inline-jobs held on the HDD 209 reaches the designated value (“3” in this example), the control unit 205 causes an offline-job in a wait state to be processed in parallel. On the other hand, when the job number designation mode has been designated with the job number designation button 11002 of FIG. 11 as well, the user can designate a value for the number of jobs held via the screen of FIG. 12. In this case, when the number of offline-jobs held on the HDD 209 reaches the designated value (“3” in this example), the control unit 205 causes an inline-job in a wait state to be processed in parallel.

In the case where a value for the number of jobs held has been designated with the job number designation button 10002, parallel execution of an offline-job and an inline-job is not permitted until the number of jobs held on the HDD 209 reaches the designated value. When the number of inline-jobs or offline-jobs held on the HDD 209 reaches the designated value, parallel execution of an offline-job and an inline-job is permitted. For example, when the number of inline-jobs held on the HDD 209 reaches the designated value, an offline-job is permitted to be executed in parallel with the execution of the inline-job. Alternatively, when the number of offline-jobs held on the HDD 209 reaches the designated value, an inline-job is permitted to be executed in parallel with the execution of the offline-job. The number of jobs held on the HDD 209 may be a value obtained by counting both the number of jobs being executed and the number of jobs in a wait state for execution, or a value obtained by counting the number of jobs in a wait state for execution without counting the number of jobs being executed. In addition, a configuration may be employed in which a counting method is set by the user from among the above counting methods. When the number of jobs held reaches the value designated with the job number designation button 10002, and parallel execution of an inline-job and an offline-job is permitted, the parallel processing may be permitted under the same conditions as those of the auto mode. Specifically, the control unit 205 permits parallel execution of an inline-job and an offline-job when the sheet conveyance path used by the inline-job and the sheet conveyance path used by the offline-job do not overlap. On the other hand, when the sheet conveyance path used by the inline-job and the sheet conveyance path used by the offline-job overlap with each other, the control unit 205 restricts parallel execution of the inline-job and the offline-job. In this case, the control unit 205 executes the offline-job and the inline-job in the order the execution requests were received. It is assumed here that the offline-job and the inline-job are stored on the HDD 209 in the order the execution requests were received, and managed by the control unit 205. In the case of restricting parallel execution of the inline-job and the offline-job, the control unit 205 may be configured so as to interpret print data used for printing the inline-job and expand image data contained in the print data, whereby the printing speed can be increased. As described above, when a value for the number of jobs held has been designated with the job number designation button 10002, and the number of jobs held is less than the designated value, parallel processing of jobs is not permitted. Accordingly, the user can proceed with the task by checking the finished quality of printed materials printed as a result of the execution of each job. On the other hand, when the number of jobs held is greater than or equal to the designated value, an inline-job and an offline-job that can be executed in parallel are executed in parallel, whereby the user's work efficiency can be increased.

FIG. 13 depicts a view illustrating an example of a UI screen displayed when the discharge process setting for inline-job has been selected in FIG. 10. When a type of inline-job has been selected by the user via the screen, and the type of inline-job that is being executed by the control unit 205 matches the type of job selected via the screen of FIG. 13, parallel processing of an offline-job is permitted.

In this screen, the types of post processes of inline-jobs that can be executed in parallel with post-processing of an offline-job are displayed from among a plurality of post processes that can be executed in the print system 1000. For example, when the print system 1000 has a configuration as shown in FIG. 3, there is no offline-job that can be executed in parallel with an inline-job that executes post-processing by the saddle stitching apparatus 200-3c while the inline-job is being executed. Accordingly, the types of post processes performed by the saddle stitching apparatus 200-3c are not displayed in FIG. 13 as selection candidates. In the screen shown in FIG. 13, selection candidates may be changed according to changes in the configuration of the print system 1000, whereby it is possible to prevent the user from inadvertently selecting an inline-job that cannot be executed in parallel with an offline-job via the screen of FIG. 13. It is assumed here that, for example, in FIG. 13, settings are saved in a state in which a glue binding (case binding) button 1301 and a glue binding (pad binding) button 1302 have been selected, and the other buttons have not been selected. In this case, the control unit 205 permits parallel processing of an offline-job only when an inline-job that executes glue binding (case binding) or glue binding (pad binding) by the glue binding apparatus 200-3b is executed. Specifically, parallel processing is permitted with an offline-job that is processed only by the saddle stitching apparatus 200-3c. In other words, parallel processing is permitted with an offline-job in which post-processing such as stapling, punching, trimming, shift discharge, saddle stitching has been designated to be carried out on sheets fed from the insert tray of the saddle stitching apparatus 200-3c. When a discharge-to-stacker button 1303 has been selected and the other buttons have not been selected in FIG. 13, the inline-job uses the print apparatus 100 and the large-capacity stacker 200-3a, but it does not use the inserter 200-3d, the glue binding apparatus 200-3b and the saddle stitching apparatus 200-3c. Accordingly, in this case, parallel processing is possible only with an offline-job that does not use the large-capacity stacker 200-3a. When a scan job button 1304 has been pressed, all types of offline-jobs are permitted to be executed in parallel with a scan job in which an original is read by using the scanner unit 201 and image data of the read original is saved on the HDD 209.

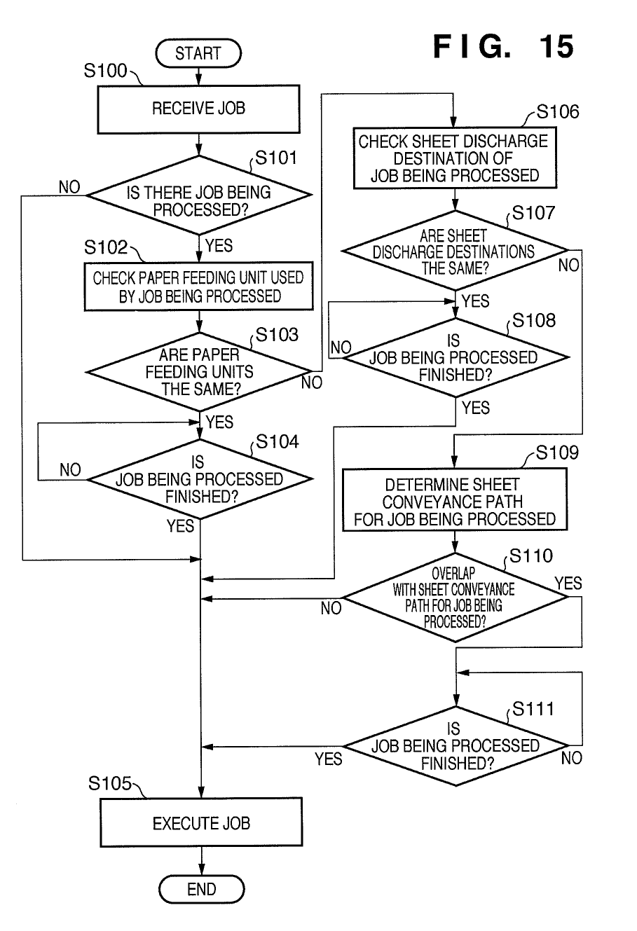

FIG. 14 depicts a view illustrating an example of a UI screen displayed when the discharge process setting for offline-job has been selected in FIG. 11. When a type of offline-job has been selected by the user via the screen, and the type of offline-job that is being executed by the control unit 205 matches the type of job selected via the screen of FIG. 14, parallel processing of an inline-job is permitted.

In this screen, the types of post processes of offline-jobs that can be executed in parallel with post-processing of an inline-job are displayed from among a plurality of post processes that can be executed in the print system 1000. It is assumed that, in FIG. 14, settings are saved in a state in which a glue binding (case binding) button 1401 or a glue binding (pad binding) button 1402 has been selected. In this case, the control unit 205 permits parallel execution of an inline-job only when an offline-job that performs glue binding (case binding) or glue binding (pad binding) by the glue binding apparatus 200-3b is executed. Specifically, parallel processing is permitted with an inline-job that uses the large-capacity stacker 200-3a and that does not use the sheet conveyance paths of the glue binding apparatus 200-3b, or a scan job.

In addition, it is assumed that settings are saved in a state in which at least one of stapling, punching, trimming, saddle stitching and folding has been selected. In this case, the control unit 205 permits parallel execution of an inline-job that does not use the saddle stitching apparatus 200-3c during the execution of the offline job by the saddle stitching apparatus 200-3c. Examples of the inline-job that does not use the saddle stitching apparatus 200-3c include inline-jobs that perform discharge-to-stacker, glue binding (case binding) and glue binding (pad binding), and a scan job.

FIG. 15 is a flowchart describing an operation of the control unit 205 performed when “auto” has been selected in FIG. 10 or 11 as a job parallel processing condition in the print system of the present embodiment. Each step shown in the flowchart of FIG. 15 is executed by the CPU 205a reading and executing a program stored in the ROM 207.

First, in S100, a job is received. The type of job received in this step may be either an inline-job or an offline-job. The control unit 205 holds the print settings and image data of the received job on the HDD 209. The control unit 205 is capable of holding a plurality of received jobs on the HDD 209, and executes the jobs held on the HDD 209 in the order they were received unless the execution order of the jobs is changed by the user. The print settings include settings of size and type of sheets, layout settings, post-processing settings, and so on that have been received via the console unit 204 or a console unit (keyboard) of the PC 104. The control unit 205 determines a sheet feeding unit that is used for the job according to the settings of size and type of sheets included in the print settings, and determines a sheet discharge destination according to the post-processing settings included in the print settings. Then, the control unit 205 stores the determined sheet feeding unit and sheet discharge destination in association with the job held on the HDD 209. Instead of setting the size and type of sheets as the print settings, the user may designate a sheet feeding unit to use. The user may also designate a sheet discharge destination. In this case as well, the control unit 205 stores the sheet feeding unit or sheet discharge destination designated by the user in association with the job held on the HDD 209.

Next, the control unit 205 advances to S101, and determines whether or not there is a job that is being processed in the print system 1000. If it is determined that there is no job being processed, because no job exists, in the print system 1000, that uses the sheet conveyance paths, the control unit 205 advances to S105, and executes the received job.

If, on the other hand, it is determined in S101 that there is a job being processed, the process advances to S102, and checks the sheet feeding unit used by the job currently processed. Then, the process advances to S103, and the control unit 205 determines whether the sheet feeding unit to be used by the job received in S100 and the sheet feeding unit used by the job being processed that was found in S102 are the same. If it is determined that they are the same, the process advances to S104, and the control unit 205 waits for the completion of the job being processed. Then, the process advances to step S105 and the control unit 205 executes the job received in S100.

If, on the other hand, it is determined in S103 that the sheet feeding unit to be used by the received job and the sheet feeding unit used in the job being processed are different from each other, the process advances to S106, and the control unit 205 checks the sheet discharge destination of the job being processed. Next, the process advances to S107, and the control unit 205 determines whether the sheet discharge destination to be used by the job received in S100 and the sheet discharge destination to which sheets are discharged as a result of the execution of the job being processed that was checked in S106 are the same. If it is determined that they are the same, the process advances to S108, and the control unit 205 waits for the completion of the job being processed. Then, the process proceeds to S105, and the control unit 205 executes the received job.

If, on the other hand, it is determined in S107 that the sheet discharge destination to which sheets are discharged as a result of the execution of the received job and the sheet discharge destination to which sheets are discharged as a result of the execution of the job currently processed are different from each other, the process advances to S109, and the control unit 205 determines a sheet conveyance path for the job currently processed. Here, the final sheet discharge destination of the job currently processed, or in other words, to which part of which apparatus connected to the print apparatus 100 the processed sheets will be discharged in the end is determined based on the designated details of the post-processing of the job. Next, the process advances to S110, and the control unit 205 determines whether the sheet conveyance path determined for the job being processed in S109 and the sheet conveyance path to be used by the job received in S100 overlap. As used herein, “the sheet conveyance paths overlap” refers to a state in which the sheet conveyance paths are at least partially the same. The state in which the sheet conveyance paths of two jobs that are to be executed in parallel intersect is also construed as “the sheet conveyance paths overlap”. In other words, when the sheet conveyance paths of two jobs that are to be executed in parallel merge, it is also construed as “the sheet conveyance paths overlap”. If it is determined in this step S110 that the sheet conveyance paths used by the two jobs do not overlap, the cprocess advances to S105, and the control unit 205 executes the received job. In other words, in this case, parallel processing of the jobs is enabled. If, on the other hand, it is determined in S110 that the sheet conveyance path of the job being processed and the sheet conveyance path to be used by the received job overlap, the process advances to S111, and the control unit 205 waits for the completion of the job currently processed. Then, the process advances to S105, and the control unit 205 processes the received job. In other words, parallel execution of the job being processed and the received job is restricted. This is because there is a possibility that conveyed sheets might run into each other when the sheet conveyance paths of two jobs merge, and in such a case, parallel processing of the jobs is not preferable. For example, when a sheet fed from the inserter tray 405 of the glue binding apparatus 200-3b is conveyed to the guide 413, the sheet conveyance path intersects with the straight path 403 of the glue binding apparatus 200-3b. In this case, there is a possibility that the sheet conveyed for the offline-job executed by the glue binding apparatus 200-3b and a sheet conveyed from the print apparatus 100 might run into each other, and if such a situation occurs, it causes a sheet jam. Accordingly, if it is determined that the sheet conveyance path of the job being processed and the sheet conveyance path to be used by the received job overlap, the control unit 205 waits for the completion of the sheet processing of the job being processed, and then starts the execution of the next job. With this configuration, it is possible to prevent the occurrence of a sheet jam caused by parallel execution of a plurality of jobs.

As described above, according to the present embodiment, it is possible to execute post-processing performed by a post-processing apparatus connected to a print system or a print apparatus, without the involvement of print processing by the print system or the print apparatus. Accordingly, it is possible to provide a flexible and convenient system. For example, an inline-job that performs printing by a print apparatus and post-processing by a post-processing apparatus and an offline-job that performs post-processing by a post-processing apparatus without printing by the print apparatus are executed efficiently. In addition, the flowchart shown in FIG. 15 is also applicable to any of the following cases:

(1) where the job being processed is an inline-job and the received job is an offline-job;

(2) where the job being processed is an offline-job, and the received job is an inline-job;

(3) where both the job being processed and the received job are inline-jobs; and

(4) where both the job being processed and the received job are offline-jobs.

In the case of (3), because the sheet conveyance paths must merge within the print apparatus 100, even when the job being processed and the received job use different sheet feeding units and different sheet discharge units, parallel execution of these jobs is restricted. In the case of (4), when the job being processed and the received job use different sheet feeding units and different sheet discharge units, and the sheet conveyance paths do not merge, parallel execution is permitted. For example, parallel execution is permitted when a glue binding process performed by the glue binding apparatus 200-3b and a stapling process performed by the saddle stitching apparatus 200-3c use different sheet feeding units and different sheet discharge units.

The above embodiment has been described in the context where the control unit 205 serves as both a unit that executes inline-jobs (first execution unit) and a unit that executes offline-jobs (second execution unit). However, the present invention is not limited thereto, and the unit that executes inline-jobs may be the control unit 205 of the print apparatus 100 and the unit that executes offline-jobs may be a CPU provided in the sheet processing apparatuses 200. In this case, the CPU of the sheet processing apparatuses 200 may be configured so as to execute offline-jobs in accordance with the instructions from the control unit 205 of the print apparatus 100.

The functions shown in the flowchart of the present embodiment can also be implemented by a processing device (CPU or processor) of a personal computer or the like executing software (program) acquired via a network or various storage media.

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent mechanisms and functions.

This application claims the benefit of Japanese Patent Application No. 2009-104546, filed on Apr. 22, 2009, which is hereby incorporated by reference herein in its entirety.

What is claimed is:

1. A print system comprising:
a first execution unit configured to execute an inline-job that performs printing by a print apparatus on sheets fed from a sheet feeding unit and post-processing on the sheets printed by the print apparatus by a post-processing apparatus;
a second execution unit configured to execute an offline-job that performs post-processing by the post-processing apparatus without performing printing by the print apparatus on sheets fed from a sheet feeding unit;
a determination unit configured to determine whether or not the inline-job and the offline-job can be executed in parallel; and
a control unit configured to perform control such that the inline-job executed by the first execution unit and the offline-job executed by the second execution unit are executed in parallel, in a case where it is determined by the determination unit that the inline-job and the offline-job can be executed in parallel, and to receive the off-line job and perform the received off-line job after execution of the inline-job has been completed in a case where it is determined by the determination unit that the inline-job and the offline-job can not be executed in parallel.

2. The print system according to claim 1, wherein the determination unit determines whether or not the inline-job and the offline-job can be executed in parallel based on whether or not a sheet conveyance path used to execute the inline-job and a sheet conveyance path used to execute the offline-job merge.

3. The print system according to claim 1, further comprising a setting unit configured to set whether or not to execute the inline-job and the offline-job in parallel,
wherein the control unit performs control such that the inline-job and the offline-job are executed in parallel in a case where a setting is made by the setting unit to execute the inline-job and the offline-job in parallel, and
the control unit receives the off-line job and performs the received off-line job after execution of the inline-job has been completed in a case where a setting is made by the setting unit to not execute the inline-job and the offline-job in parallel.

4. The print system according to claim 1, further comprising a condition setting unit configured to set a condition for permitting parallel execution of the inline-job and the offline-job,
wherein the control unit performs control such that the inline-job and the offline-job are executed in parallel in a case where the condition set by the condition setting unit is satisfied, and
the control unit receives the off-line job and performs the received off-line job after execution of the inline-job has been completed in a case where the condition is not satisfied.

5. The print system according to claim 4, wherein the condition setting unit is capable of setting a condition that a sheet conveyance path used by the inline-job and a sheet conveyance path used by the offline-job do not merge as the condition.

6. The print system according to claim 4, wherein the condition setting unit is capable of setting a condition that the number of inline-jobs or offline-jobs in a wait state for execution is greater than or equal to a predetermined value as the condition.

7. The print system according to claim 4, wherein the condition setting unit is capable of setting a condition that the type of post-processing performed by execution of the inline-job or the type of post-processing performed by execution of the offline-job is a predetermined type as the condition.

8. The print system according to claim 7, further comprising a selection unit configured to select the predetermined type with an instruction from a console unit.

9. A method of controlling a print system, the method comprising:
a first execution step of executing an inline-job that performs printing by a print apparatus on sheets fed from a sheet feeding unit and post-processing by a post-processing apparatus on the sheets printed by the print apparatus;
a second execution step of executing an offline-job that performs post-processing by the post-processing apparatus without performing printing by the print apparatus on sheets fed from a sheet feeding unit;
a determination step of determining whether or not the inline-job and the offline-job can be executed in parallel; and
a control step of performing control such that the inline-job executed in the first execution step and the offline-job executed in the second execution step are executed in parallel, in a case where it is determined in the determination step that the inline-job and the offline-job can be executed in parallel, and to receive the off-line job and perform the received off-line job after execution of the inline-job is completed in a case where it is determined in the determination step that the inline-job and the offline-job can not be executed in parallel.

10. A storage medium storing a program for causing a computer to execute the control method according to claim 9.
